(19) United States
(12) Patent Application Publication
(10) Pub. No.: US 2018/0309537 A1
(43) Pub. Date: Oct. 25, 2018

(54) Motion Safety Interlock for Remote Control Systems

(71) Applicants: Herbert Ross Gingold, Longwood, FL (US); Victoria Elizabeth Gingold, Longwood, FL (US)

(72) Inventors: Herbert Ross Gingold, Longwood, FL (US); Victoria Elizabeth Gingold, Longwood, FL (US)

(21) Appl. No.: 15/959,627

(22) Filed: Apr. 23, 2018

Related U.S. Application Data
(60) Provisional application No. 62/489,023, filed on Apr. 24, 2017.

(51) Int. Cl. H04K 3/00; B60P 3/34; B60P 7/06

(52) U.S. Cl. CPC H04K 3/415; B60Y 2302/07; B60P 7/06; B60P 3/34

(57) ABSTRACT

A device that controls the electrical connections to an accessory actuation solution, with integrated motion detection as an activation interlock, and diagnostic monitoring of the accessory. The device can use relays, or electronic drive solutions, to control electric or electro-hydraulic actuation devices. The device measures accelerations, rotations, voltages, currents, pressures, temperatures and other signals to provide diagnostic information about the accessory being controlled and vehicle to ensure safe operating conditions exist to activate the device. The device prohibits activation of the actuator if motion above a threshold is detected in more than one degree of freedom. The device connects with a dedicated remote control, or a third party device running a software application, either of which can control the actuation of the device and receive diagnostic information, The application collects and analyzes data, directly or indirectly via the dedicated remote, on the performance of the actuator for analysis.

### CROSS-REFERENCE TO RELATED APPLICATIONS

This application claims the benefit of U.S. Provisional Application No. 62/489,023 filed on Apr. 24, 2017, the contents of which are incorporated herein by reference.

### BACKGROUND OF THE INVENTION

The statements in this section merely provide background information related to the present disclosure and may not constitute prior art.

The present invention relates generally to remote control solutions for electrically or electro-hydraulically operated features of a vehicle, and more particularly to utility and recreational vehicles typified by work trailers, horse trailers, motor homes, travel trailers, boats and boat trailers, and off road vehicles.

Utility and recreational vehicles features have evolved, in the form of dynamic accessories. These accessories are typically electrically or electro-hydraulically operated, and use rotational motors or liner/rotational actuators to activate or engage the function. As an example, in the motor home and travel trailer sector, vehicles have progressed from basic boxes to expanding designs with electrically driven or actuated jacks, awnings and slide out sides, to level the unit, provide shade and increase the useful space when the vehicle is stationary. These electrically actuated elements of the recreational vehicle are typically controlled by a two position, normally open, momentary switch located inside the vehicle. Since the elements, typically but not limited to jacks, awnings and slide out rooms, that are in motion are outside the vehicle and cannot be viewed from inside where the switch is located, risk occurs when only one person is operating the equipment. Having two people to perform the task is acceptable, but not ideal. For this reason remote control solutions are ideal to allow safe actuation of the RV element as the operator is able to control and observe the element from the optimal location to ensure safety. Typical remote controls are unidirectional; there is no feedback to the operator, other than visual observation of the accessory in motion.

There is a clear gap in the safety of these existing solutions in remote control solutions, as they typically have no safety interlock when in transit and no form of feedback or diagnostic capability to allow the determination of safe operating conditions. Due to the fact that the RV elements are electrically active while being transported, accidental activation via the remote control system is real and present danger. A reliable remote control should have a safety interlock to prevent operation when the RV is being transported. A vehicle independent solution would be ideal for safety. Additionally, the ability to determine the electrical current that is being delivered, at what voltage and temperature, and if there are any patterns to the current flow, and the time of operation, allows for performance analysis of the RV actuation system to determine safe operating conditions. Activation in unsafe operating conditions would result in damaging results as best. This same data can be extrapolated across multiple devices to determine the performance of the overall vehicle.

In light of the above, it would be beneficial to provide a remote control solution that incorporates a reliable safety interlock and real time diagnostic capabilities.

### BRIEF SUMMARY OF THE INVENTION

The presented invention is directed to a remote control device for electric motor or actuator driven control of a vehicle accessories. One embodiment of the present invention includes a relay arrangement that controls the electric actuator. The embodiment has a three dimensional linear motion detection sensor used to implement an independent safety interlock by multiple degree of freedom analysis of the acceleration data. The motion analysis is based on having motion in excess of variable thresholds in more than one degree of freedom. The embodiment has sensors to measure diagnostic information to determine the performance of the accessory being controlled. The embodiment has a control software application hosted on a third party smart phone platform which provides a remote control solution for the actuated accessory of a vehicle. The embodiment provides an accessory independent safety interlock and real time performance diagnostics of the accessory and vehicle.

In one embodiment the device uses rotational acceleration measurements.

In one embodiment the device uses linear and rotational acceleration measurements.

In one embodiment the device uses electronic power control devices to implement the electric signals for control of the feature.

In one embodiment the device uses electronic power control for variable speed motor control in electric drive solutions.

In one embodiment a dedicated physical remote control key fob can display safety and diagnostics via visual indications, but can also forward data to an application.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exemplary block diagram of a remote control system with the device installed.

FIG. 2 is exemplary electronics board of the device.

FIG. 3 is exemplary firmware flow diagram of the electronics board processor.

FIG. 4 is an exemplary software application screen.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

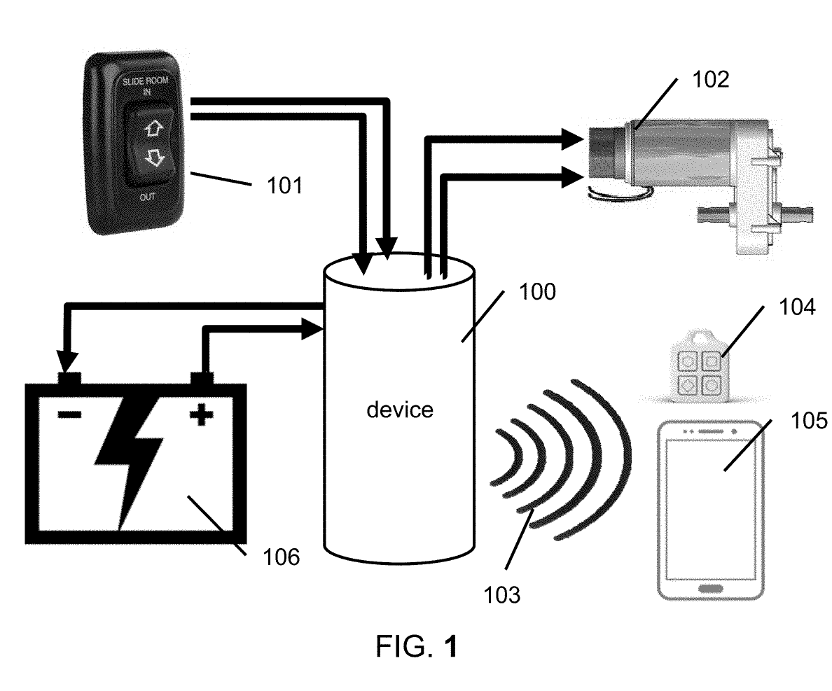

FIGS. 1-4 illustrate an embodiment of a remote control device that is useful for understanding the inventive concepts disclosed herein. Although the device is described for use with a vehicle, the invention is not limited to any particular use or industry as the device could be utilized for any number of different purposes, to control any number of electrically controllable objects, where motion detection and diagnostics enable safe operation.

In the preferred embodiment the device 100 provides a novel and unique way of incorporating a safety interlock and data collection via the remote control system, which provides valuable features and benefits over the state of the art.

In FIG. 1, the device 100 is wired in-line between the existing control switch 101 and the device to be actuated 102.

In FIG. 1, the device 100 is connected wirelessly 103 to a smart phone 105 that supports industry standard wireless connections 103. A dedicated key fob 104 can also be employed that uses the same standard wireless connections 103.

In FIG. 1, the device 100 is connected to a power source 106.

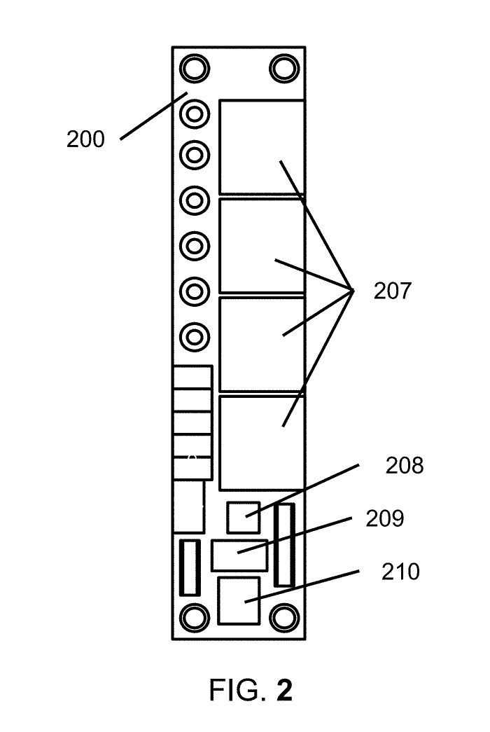

In FIG. 2, referring back to FIG. 1 the device 100 has a printed circuit board 200 that has relays 207 to control the electricity going to the actuator 102. The relays 207 are controlled by a radio/processor 210 that also provides the connectivity to the standard wireless connection 103.

In FIG. 2, referring back to FIG. 1 the device 100 has a printed circuit board 200, that has a three dimensional motion detection device 208 that inhibits actuation if motion is detected in multiple axis's of motion, linear and/or rotational.

In FIG. 2, referring back to FIG. 1 the device 100 has a printed circuit board 200, that has sensors 209 that monitor time of use, temperature, voltage and current to provide diagnostic information on the actuation 102 mechanism for performance analysis and to ensure safe operating conditions.

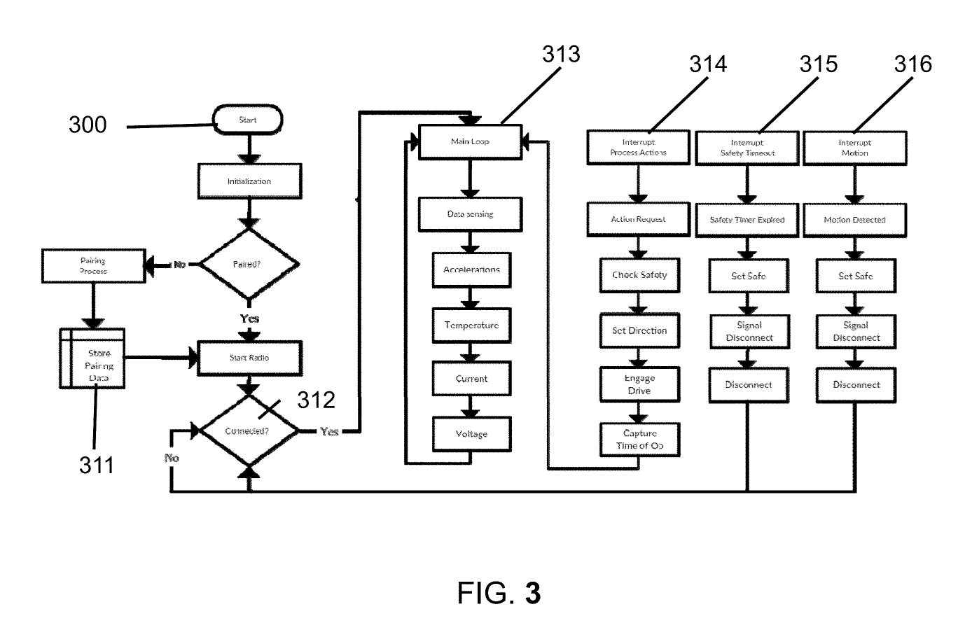

In FIG. 3, Firmware 300 that controls the operating behavior of referring back to FIG. 1 the device 100. The firmware 300 has key based pairing 311 to ensure security. The firmware 300 enables valid connections 312. The firmware 300 runs diagnostics continually while connected in the Main loop 313. The action interrupt 314 allows for activation only when conditions are safe as determined by , referring back to FIG. 2 the processor 210 from the measurements of the sensors 208 and 209. The interrupt safety timeout 315 ensures that referring back to FIG. 1 the device 100 does not stay connected indefinitely. The interrupt motion 316 occurs when unsafe motion is sensed in more than one degree of freedom.

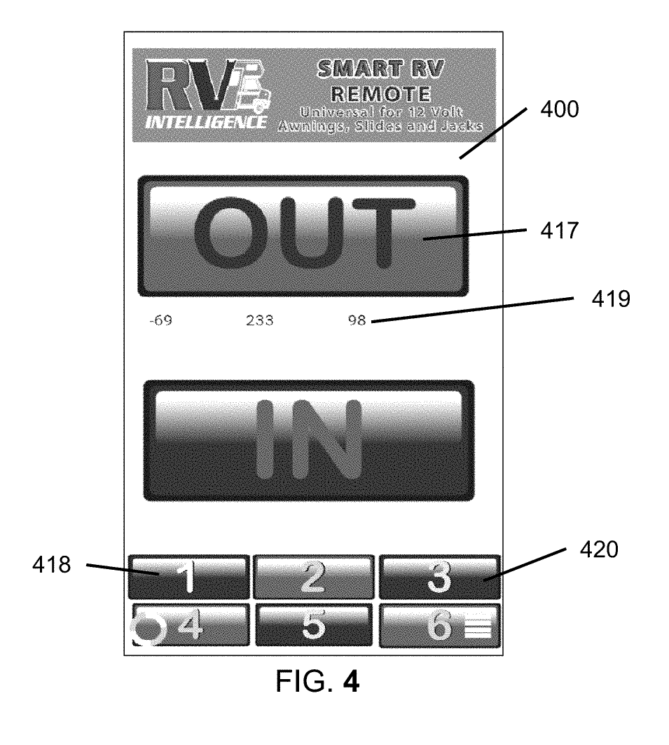

In FIG. 4, the main screen of a smart phone application 400 that, referring back to FIG. 1 executes on a smart device 105. The application 400 has a routine 418 for, referring back to FIG. 1 a standard wireless connection 103 to the device 100.

In FIG. 4, the main screen of a smart phone application 400 that executes referring back to FIG. 1 on a smart device 105. The application 400 allows for activation control 417 referring back to FIG. 1 of the device 100.

In FIG. 4, the main screen of a smart phone application 400 that executes referring back to FIG. 1 on a smart device 105. The application 400 allows for referring back to FIG. 1 multiple devices 100 to be controlled 420.

In FIG. 4, the main screen of a smart phone application 400 that executes referring back to FIG. 1 on a smart device 105. The application 400 has advanced features, voice activation, audio report of activity, diagnostic analysis of sensor data 419.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of Stated features, integers, steps, operations, elements, and/or components, but do not preclude the pres steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The claimed invention is:

1. A device that actuates an electrical circuit based on receiving control signals from a wireless control device:
That it has a motion detection capability, that is used to prohibit actuation if the device is in linear and/or rotational motion determined to be an unsafe operating condition;
That the motion detection function and analysis do not require any signal connection to any part of the actuator or vehicle other than mechanical attachment to the structure;
That the disconnection is generated by the device and the wireless control device referenced in claim 2 cannot reestablish a connection unless safe operating conditions exist;
That it does variable speed control using electronic power control devices;
That it has measurement capability to monitor parameters of actuation mechanism including but not limited to: motion in all degrees of freedom, temperature ambient and equipment, voltage supply and at key operational points, electrical current flow and patterns;
That the parameter measurements are used to determine actuator performance and safe operating conditions;
That it can be installed in line or in parallel between the original control device and the actuator.

2. A user supplied wireless control device known as a smart phone, that connects to one or more devices as described in claim 1:
The device described in claim 1 connects and is controlled by the user supplied wireless control device executing an application described in claim 3;
The user supplied wireless control device can connect and control multiple devices described in claim 1 simultaneously;
The user supplied wireless control device can connect with a key fob described in claim 3;
The user supplied wireless control device collects system data including but not limited to motion in all degrees of freedom, temperature ambient and equipment, voltage supply and at key operational points, electrical current flow and patterns.

3. A software application that is hosted on a wireless control device described in claim 2 that interacts in novel and useful ways with the device described in claim 1:
The application can control multiple devices described in claim 1;
The application can be voice controlled and voice respondent in control of the device described in claim 1;
The application can create sequences of activity in the device described in claim 1 that implement automatic activities described by but not limited to automatic leveling, automatic retraction, automatic extension, automatic engagement of any capability;
That has sensor data collection and analysis capability for the performance and safe operation of the actuation system and vehicle;
The application can connect with a dedicated key fob as described in claim 2 to obtain stored diagnostic data.
